(19) United States
(12) Patent Application Publication
(10) Pub. No.: US 2014/0149205 A1
(43) Pub. Date: May 29, 2014

(54) Method and Apparatus for an Online Advertising Predictive Model with Censored Data

(71) Applicant: ADOBE SYSTEMS INCORPORATED, San Jose, CA (US)

(72) Inventors: Zhenyu Yan, Sunnyvale, CA (US); Andrew I. Schein, Sunnyvale, CA (US)

(73) Assignee: Adobe Systems Incorporated, San Jose, CA (US)

(21) Appl. No.: 13/689,298

(22) Filed: Nov. 29, 2012

(51) Int. Cl. G06Q 30/02

(52) U.S. Cl. CPC G06Q 30/0244
USPC 705/14.43

(57) ABSTRACT

A censored observation for an online advertising campaign may be received for a first given time period. It may be determined that an amount spent on the online advertising campaign met a budget constraint such that the online advertising campaign was interrupted during the first given time period. Based on the received censored observation and one or more campaign parameters for the first given time period, a predictive model for predicting the result of a new online advertising campaign may be generated.

### BACKGROUND

In online advertising, advertisers usually set a campaign budget constraint to prevent overspending. The actual responses (e.g., impressions, clicks, conversions, cost, revenues, etc.) may only be partially observable due to the hard spending cap imposed by the budget constraint. If the spending hits the budget, the observed responses may be less than the actual responses that could be reached without the budget constraint. Traditional models built on such partially observable data are biased by treating the capped response as the actual response or by deleting observations with capped responses. Either way, traditional models introduce bias and do not accurately reflect what the actual responses could be without the budget constraint.

### SUMMARY

This disclosure describes techniques and structures for generating a predictive model for predicting a result of an online advertising campaign. One embodiment may include receiving a censored observation for an online advertising campaign for a first given time period. The censored observation may correspond to a first response value. One or more campaign parameters (e.g., bid amount, etc.) may be defined for the first given time period. It may be determined that an amount spent on the online advertising campaign met a budget constraint such that the online advertising campaign was interrupted during the first given time period. Based on the received indication and the one or more campaign parameters for the first given time period, a predictive model for predicting the result of a new online advertising campaign may be generated. Generating the model may include determining a likelihood that a larger response value than the first response value would have occurred for the online advertising campaign absent the first budget constraint.

### BRIEF DESCRIPTION OF THE DRAWINGS

FIG. 1 is a block diagram that illustrates an example system that may implement online advertising prediction, according to some embodiments.

FIG. 2 is a flowchart that illustrates a method for online advertising prediction, according to some embodiments.

FIG. 3 illustrates a chart of example predictive models, according to some embodiments.

FIG. 4 illustrates an example computer system that may be used in accordance with one or more embodiments.

### DETAILED DESCRIPTION OF EMBODIMENTS

The following specification describes generating a predictive model for predicting results of a new online advertising campaign. Generating the predictive model may include considering that a larger response value than the observed response value likely would have occurred for censored observations for an online advertising campaign. Censored observation is used herein to describe an observation in which a budget constraint was met such that the online advertising campaign was interrupted thereby blocking a larger response value from occurring. In some embodiments, the predictive model may take into account the likelihood that a larger response value than the observed response value (e.g., number of clicks, number of conversions, number of impressions, amount of revenue, amount of cost, etc.) would have occurred for the online advertising campaign absent the budget constraint. Responses may include clicks, conversions, impressions, revenue, cost, etc. Accordingly, a response value may be a count or value associated with one or more of the responses. For example, a response value may be the number of clicks, number of impressions, number of conversions, an amount of revenue measured in a unit of currently, or an amount measured per unit of day (e.g., new daily revenue, etc.).

In the following detailed description, numerous specific details are set forth to provide a thorough understanding of claimed subject matter. However, it will be understood by those skilled in the art that claimed subject matter may be practiced without these specific details. In other instances, methods, apparatuses or systems are not described in detail below because they are known by one of ordinary skill in the art in order not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

“First,” “Second,” etc. As used herein, these terms are used as labels for nouns that they precede, and do not imply any type of ordering (e.g., spatial, temporal, logical, etc.). For example, for an online advertising campaign, the terms “first” and “second” response values can be used to refer to any two response values for the online advertising campaign. In other words, the “first” and “second” response values are not limited to logical response values 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

Various embodiments of methods and apparatus for online advertising prediction are described. Some embodiments may include a means for response prediction. For example, a prediction module may receive a censored observation for an online advertising campaign, determine that an amount spent on the online advertising campaign met a budget constraint such that the advertising campaign was interrupted, and based on the received observation and one or more campaign parameters, generate a predictive model for predicting the result of a new online advertising campaign including determining the likelihood that a larger response value would have occurred for the campaign absent the budget constraint. The prediction module may, in some embodiments, be implemented by program instructions stored in a computer-readable storage medium and executable by one or more processors (e.g., one or more CPUs or GPUs) of a computing apparatus. The computer-readable storage medium may store program instructions executable by the one or more processors to cause the computing apparatus to perform receiving a censored observation for an online advertising campaign, determining that an amount spent on the online advertising campaign met a budget constraint such that the advertising campaign was interrupted, and based on the received observation and one or more campaign parameters, generating a predictive model for predicting the result of a new online advertising campaign including determining the likelihood that a larger response value would have occurred for the campaign absent the budget constraint, as described herein. Other embodiments may be at least partially implemented by hardware circuitry and/or firmware stored, for example, in a non-volatile memory.

Although certain embodiments are described in terms of responses (e.g., clicks, conversions, impressions, etc.) made with respect to a webpage and/or website, it will be appreciated that the techniques disclosed herein may be employed with other forms of network content sites, such as documents with a traversable tree-like hierarchy (e.g., XML, HTML, etc.).

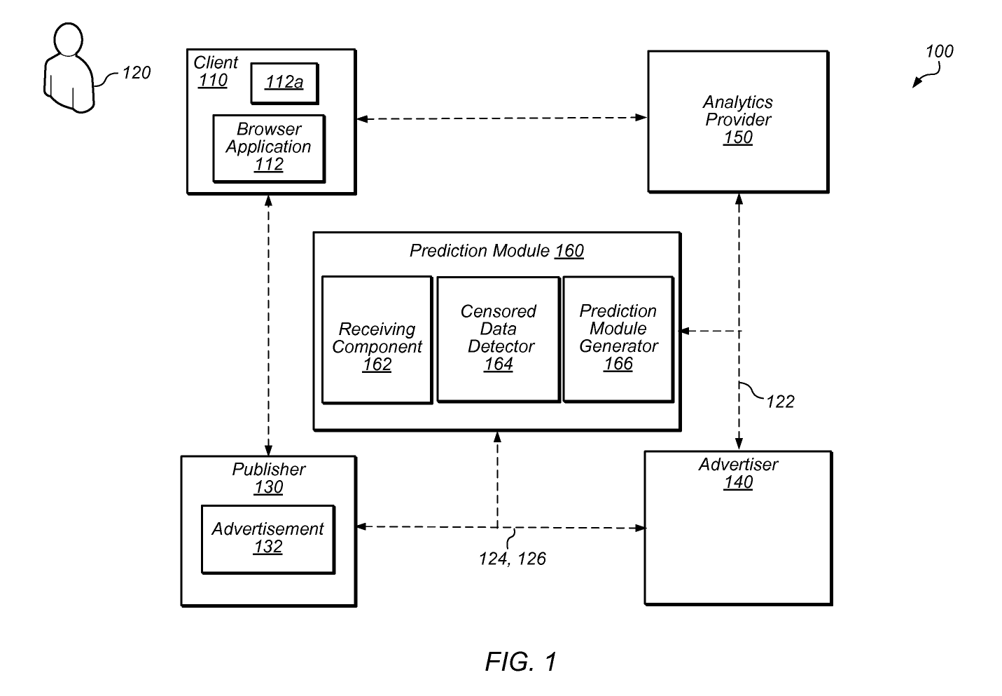

Turning now to the figures, FIG. 1 is a block diagram that illustrates an online advertising prediction system 100, according to some embodiments of the present disclosure. In the illustrated embodiment, system 100 includes client 110, publisher 130, advertiser 140, analytics provider 150, and prediction module 160. Client 110, publisher 130, advertiser 140, analytics provider 150, browser application 112, prediction module 160, receiving component 162, censored data detector 164, and prediction module generator 164 may each include, employ or be executed on one or more computer systems. Each of client 110, publisher 130, advertiser 140, analytics provider 150, and prediction module 160 may be communicatively coupled to one another via a network. The network may include any channel for providing effective communication between the various entities of system 100. In some embodiments, the network may include an electronic communication network, such as the internet, a local area network (LAN), wireless LAN (WLAN), WiMAX network, cellular communications network, or the like. For example, the network may include an internet network used to facilitate communication between the various entities (e.g., client 110, publisher 130, advertiser 140, analytics provider 150, and prediction module 160) of system 100.

Publisher 130 may include a source of information/content (e.g., a file defining display information for one or more content items, such as a website) that is provided to client 110. For example, publisher 130 may include media portals or websites used to present media to client 110. In some embodiments, publisher 130 may be a content provider that includes a content server (e.g., network content server, web content server). The content server may include content, such as network and/or website content (e.g., web pages), stored thereon that are accessed and loaded by client 110 when viewing respective webpages of publisher 130. The content may include data collection code (e.g., for collecting analytics data regarding responses) and online advertisements 132 provided by advertiser 140, as described in detail below.

Client 110 may include a computer, mobile device (e.g., cellular phone, tablet device, etc.), or similar device used to access content provided by publisher 130. In some embodiments, client 110 may include a computer employing a browser application 112 that is used to interact with webpages and websites provided by publisher 130. For example, browser application 112 may render a webpage of publisher 130. Rendering may include executing HTML code for the webpage provided by publisher 130 and may also include executing HTML code for an online advertisement 132 provided by advertiser 140. As a result, browser application 112 may also generate an appropriate request for data from various servers of system 100 to assemble the webpage for display on client 110. The webpage may be viewed by a user via a monitor or similar presentation device at client 110.

In some embodiments, advertiser 140 may provide online advertisement 132. For example advertiser 140 may provide HTML code for online advertisement 132. In various embodiments, advertiser 140 may provide online advertisement 132 directly to client 110 or may provide online advertisement 132 to client 110 via publisher 130.

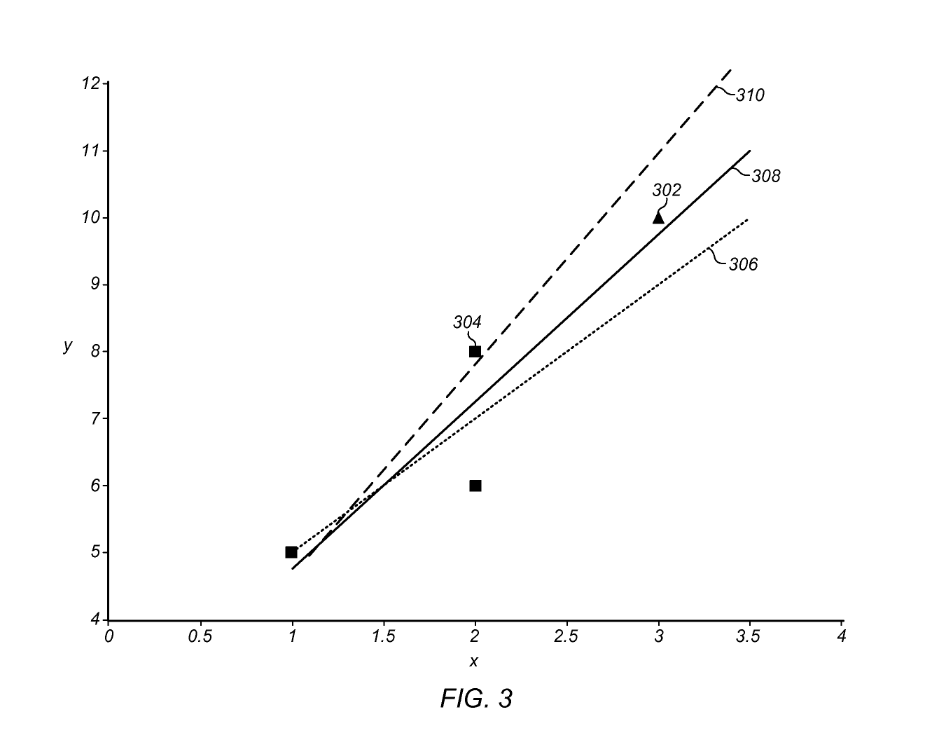

Publisher 130 may include a system for the collection, from client 110, and processing of data indicative of responses (e.g., impressions, clicks, conversions, cost, revenues, etc.) to provide an observation 122 and/or 124 that is indicative of the responses to prediction module 160. Publisher 130 may include a third-party website traffic statistic service that is a physically separate entity from publisher 130. As described herein, the observation may be for a given time period for an online advertising campaign. One or more campaign parameters may be defined for the given time period. Campaign parameters may include bid amount, duration, type of bid, etc., among others. Example observations are shown in the graph of FIG. 3.

Analytics provider 150 may, in addition to or instead of publisher 130, include a system for the collection, from client 110, and processing of data indicative of responses (e.g., impressions, clicks, conversions, cost, revenues, etc.) to provide an observation 122 and/or 124 that is indicative of the responses to prediction module 160. Analytics provider 150 may include a third-party website traffic statistic service that is a physically separate entity from analytics provider 150. As described herein, the observation may be for a given time period for an online advertising campaign. One or more campaign parameters may be defined for the given time period. Campaign parameters may include bid amount, duration, type of bid, etc., among others. Example observations are shown in the graph of FIG. 3.

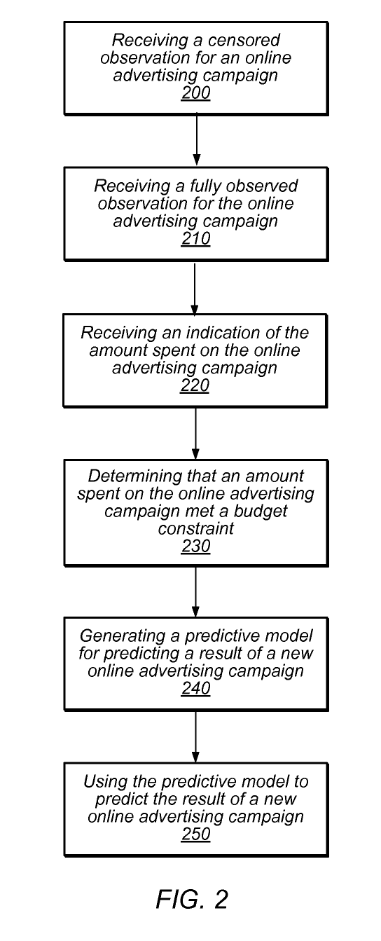

In the illustrated embodiment, prediction module 160 may be configured to implement the disclosed response prediction techniques, as described at FIG. 2. In one embodiment, prediction module 160 may include receiving component 162 to receive an observation 122 and/or 124 that is indicative of the responses from analytics provider 150 and/or publisher 130, respectively. The received observation may be censored or fully observed. Note that although prediction module 160 is illustrated as a standalone module in FIG. 1 for ease of explanation, it may likewise be implemented at analytics provider 150, publisher 130, advertiser 140, or elsewhere. Prediction module 160 and receiving component 162 may also receive, from publisher 130, an indication of an amount spent 126 on an advertising campaign.

In one embodiment, prediction module 160 may include censored data detector 164 to determine if an observation has been censored. For example, such determining may include determining that an amount spent on the online advertising campaign met a budget constraint such that the advertising campaign was interrupted. Prediction module 160 may also include prediction module generator 166 to generate a predictive model for predicting the result of a new online advertising campaign including determining the likelihood that a larger response value that would have occurred for the campaign absent the budget constraint. Such generation of the predictive model may be based on the received observation and one or more campaign parameters.

In some embodiments, prediction module 160 may generate a prediction of results for an online advertising campaign based on the predictive model. For instance, prediction module 160 may receive one or more new campaign parameters for a new campaign and may predict a response value or some other results of the new campaign by applying the predictive model to the new campaign parameters. Prediction generation may occur in a stand-alone application or may occur as part of a browser plug-in. A report may be provided to a user interface. Such a user interface may be accessible to advertiser 140 in some embodiments.

In some embodiments, a user 120 interacts with a device at client 110, to execute a software application, such as browser application 112 of client 110, for accessing and displaying one or more webpages 112a. In response to a user command, such as clicking on a link or typing in a uniform resource locator (URL), browser application 112 may issue a webpage request to a content server of publisher 130 via the network (e.g., via the Internet). In response to the webpage request, the content server may transmit the corresponding webpage code (e.g., HTML code corresponding to webpage 112a), including code corresponding to advertisement 132, to browser application 112. Browser application 112 may interpret the received webpage code to display the requested webpage to user 120 at client 110. Browser application 112 may generate additional requests for content (not shown in FIG. 1) from the server, as needed. In one embodiment, the content may include advertisement 132.

In some embodiments, client 110 also transmits webpage visitation tracking information (e.g., data indicative of responses) to publisher 130 and/or analytics provider 150. Then, analytics provider 150 and/or publisher 130 may provide an observation 122 and/or 124, respectively, which is indicative of the responses, to prediction module 160. Additionally, publisher 130 may provide an indication of an amount spent 126 to prediction module 160.

Turning now to FIG. 2, one embodiment of online advertising prediction is illustrated. While the blocks are shown in a particular order for ease of understanding, other orders may be used. In some embodiments, the method of FIG. 2 may include additional (or fewer) blocks than shown. Blocks 200-250 may be performed automatically or may receive user input. In one embodiment, the method of FIG. 2 may be performed by prediction module 160.

As illustrated at 200, a censored observation for an online advertising campaign for a given time period (e.g., first given time period) may be received. One or more campaign parameters (e.g., bid amount, bid type, duration of the campaign, etc.) may be defined for the first given time period. The censored observation may be indicative of a first plurality of responses (e.g., impressions, clicks, conversions, cost, revenues, etc.). For example, the censored observation may correspond to a first response value (e.g., number of impressions, clicks, or conversions, or cost or revenue amount, such as a dollar amount). The censored observation may be associated with the campaign parameter(s). As a simple example, the censored observation may correspond to 1000 clicks and a bid amount of $0.02 per click.

In various embodiments, the censored observation may be received from a publisher of an online advertisement of the advertising campaign and/or an analytics provider. For example, the publisher or analytics provider may collect data indicative of the responses, such as first party tracking data (e.g., cookies) or third party data from a data aggregator. Such data may include the time and/or date of the response, demographic information of the user associated with the response (e.g., user who clicked on the advertisement impression), among other data. The observation may be the raw or processed data indicative of the responses. As one example, the responses may be processed and the observation received at block 200 may be the response value. For example, if 200 clicks occurred for the online advertising campaign during the first given time period, the publisher and/or analytics provider may collect data regarding the 200 clicks. The prediction module may then receive, from the analytics provider, an observation that 200 clicks have occurred. As described herein, the response value(s) may correspond to a given time period.

In various embodiments, the prediction module may poll the analytics provider for the observation or the analytics provider may automatically provide the observation to the prediction module. For instance, analytics provider may provide the observation to the prediction module periodically, such as once every hour, once a day, or at some other interval.

In some embodiments, one or more other observations may also be received. For example, as shown at 210, a fully observed observation may be received for a respective time period. Note that the other observation(s) may likewise be other censored observations and/or fully observation observations for a respective time period. As a simple example, a fully observed observation may be received for a second given time period. The fully observed observation may correspond to a second response value. Additionally, another one or more campaign parameters may be defined for the second given time period. In some examples, the campaign parameters may be the same for each observation/time period, or they may differ in some respect (e.g., different bid amount). Thus, in the example above, the campaign parameters for the first and second time periods may be the same or may differ in some respect.

As illustrated at 220, an indication of the amount spent on the online advertising campaign may be received, for example, from the publisher of the online advertisement.

At 230, the amount spent on the online advertising campaign may be determined as having met a budget constraint (e.g., a first budget constraint), which may be met before the end of the allotted budget time period. The determination that the amount spent has met the budget constraint may be based on that received indication of the amount spent and the budget constraint. Consider a simple example in which a budget constraint is $10 and the amount spent is equal to $0.01 times the response value (e.g., number of clicks). An indication may be received that $10 has been spent because 1000 responses have occurred (1000×0.01=10). In some embodiments, calculation of the amount spent may be performed by the publisher. The amount spent may then be provided to prediction module 160 to make the determination of block 210. Continuing the example, the amount spent, $10 in this example may then be compared with the budget constraint, also $10 in this example. In such an example, the amount spent may be determined as meeting the budget constraint. Note that meeting the budget constraint may include equaling or exceeding the budget constraint. For example, in some situations, the amount spent may be allowed to exceed the budget constraint (e.g., by a small dollar amount, by a small percentage amount, etc.). In other situations, the budget constraint may be a hard cap that blocks any spending above the budget. In either type of situation, equaling or exceeding the budget constraint may be considered as meeting the budget constraint.

As illustrated at 240, a predictive model for predicting a result of a new online advertising campaign may be generated, for example, by prediction module 160. Such generation of the predictive model may be based on the observation received at block 200 and the one or more campaign parameters for the given time period. Generating may include determining the likelihood that a larger response value would have occurred for the online advertising campaign absent the budget constraint.

In embodiments in which multiple observations are received, the predictive model may also be based on the campaign parameter(s) corresponding to each of the observations and on each of the received observations (e.g., the observations received at blocks 200 and 210). For fully observed observations, the actual response value may be the number and/or value of the plurality of responses regardless of the budget constraint corresponding to the time period of the fully observed observation.

In some embodiments, determining the likelihood that a larger response value would have occurred for the online advertising campaign absent the budget constraint may include applying a regression technique to the observation. In various embodiments, determining the likelihood that a larger response value would have occurred for the online advertising campaign absent the budget constraint may include applying a maximum likelihood estimation (MLE) technique to the observation to maximize the likelihood of occurrences of both the fully and partially observed responses. The following description further elaborates on example predictive models and MLE techniques.

Consider the censoring of the actual response value in a censored observation to be a censored regression problem, which will first be considered without any covariates. Let random variable y* be normally distributed with mean μ and variance σ². A random variable y is subject to right censorship if

$$y = \{ \begin{matrix}c & if {y}^{*} \geq c \\ {y}^{*} & otherwise\end{matrix} \qquad Eq . ( 1 )$$

where c is a given constant. Note that left censorship can be expressed in a similar way.

Let Φ be the cumulative distribution function of the standard normal distribution and J* be the probability density function of y*. The density function for a single observation is:

$$\begin{matrix}f ( y ) = [ {{P ( {y}^{*} \geq c )}^{j} [ {f}^{*} ( y ) ]}^{1 - j} \\ = {{[ 1 - Φ ( \frac{c - μ}{σ} ) ]}^{j} [ \frac{1}{2 π σ} {e}^{- \frac{1}{2} {( \frac{y - μ}{σ} )}^{2}} ]}^{1 - j}\end{matrix} \qquad Eq . ( 2 )$$

where j=1 (censored) if y=c and j=0 (uncensored or fully observed) otherwise. For some cost modeling embodiments, y* may be the actual number of clicks to be estimated and y may be the number of clicks that can be observed. The value for j may be a Boolean value. j may be determined directly by the following rule: j=1 if the cost is equal to (or greater than in some cases) the budget; and j=0 if the cost is less than the budget. c may be set equal to the observed number of clicks (e.g., y) whenever j=1. As can be seen from Eq. (2), the left hand side is 1 if j=0 whereas the right hand is represented by a normal distribution. Similarly, the right hand side is 1 if j=1 and the left hand side is 1 minus the cumulative distribution function. In this manner, the left hand side attempts to maximize the probability that the forecast is at or above the observed data.

Now, the censored regression will consider the covariates. Consider the following regression equation:

y=Xβ+ε Eq. (3)

where ε is assumed to be normally distributed with mean 0 and variance σ². If y can be observed through its entire range, then estimation of the parameters is straightforward. If, however, the observed variable y is left or right censored, then ordinary least squares estimates may be biased. In such a scenario, estimation of the parameters may be performed by maximum likelihood. Let [yᵢ,xᵢ] be the value of dependent variable y and covariates x of observation i in a random sample with N independent observations. In this example, only right censorship is considered. yᵢ* is assumed to be normally distributed with mean β^{T}xᵢ and variance σ². fᵢ* may be the probability density function of yᵢ*. Here, yᵢ* (the actual number of clicks absent a budget constraint) may be determined by determining the likelihood of [yᵢ,xᵢ] as:

$$\begin{matrix}{L}_{i} = [ {{P ( {y}_{i}^{*} \geq {c}_{i} )}^{j} [ {f}_{i}^{*} ( {y}_{i} ) ]}^{1 - j} \\ = {{[ 1 - Φ ( \frac{{c}_{i} - {β}^{T} {x}_{i}}{σ} ) ]}^{j} [ \frac{1}{2 π σ} {e}^{- \frac{1}{2} {( \frac{y - {β}^{T} {x}_{i}}{σ} )}^{2}} ]}^{1 - j}\end{matrix} \qquad Eq . ( 4 )$$

where j=1 (censored) if y=c and j=0 (uncensored or unobserved) otherwise. The likelihood for the N observations may be:

$$L = {\prod }_{i = 1}^{N} {L}_{i} . \qquad Eq . ( 5 )$$

By maximizing the total likelihood L for all the observations, estimates of parameters β and σ may be obtained. In one embodiment, a β that makes the response value as high as possible above the number of observed responses may be determined. The distribution of yᵢ* may then be determined by yᵢ*˜N(β^{T}xᵢ,σ²). By finding β and σ, a model may be generated that allows predictions to take place. As described herein, the model may be used to predict results (e.g., number of predicted responses) for a new campaign or adjust or create a new campaign by setting campaign parameters (e.g., bid amount) that optimize the predicted results.

The following describes an example of predictive cost modeling according to the method of FIG. 2 based on censored regression. In some embodiments, cost modeling for online advertising, for example, for each bid unit (or ad id), the number of clicks received per day may be estimated as a function of the bidding strategy (bid), which may be expressed mathematically as click=f(bid). The cost or revenue prediction can eventually be derived by multiplying the predicted number of clicks with a cost per click (cpc) or revenue per click (rpc), which can also be estimated from historical data. The cost and revenue may be represented as cost=click*cpc and revenue=click*rpc. The historical dataset may contain a tuple of elements, which may include the bid and number of clicks received per day. For some types of advertisements, such as advertisements on social networking websites, the volumes of impressions and clicks can be very high at a certain bid level. Once the cost hits the budget, the number of clicks cannot continue to accumulate. For those cases, the actual numbers of clicks that can be attracted given particular bids are only partially observed. The actual number of clicks that could be observed should be equal to or greater than the observed ones.

In some embodiments, for cost modeling, two models may be fit. The single covariate for both models may be the bid. Represented as equations, click=f(bid) and cpc=f(bid). With the estimates of click and cpc for a given bid, the cost estimate is calculated by cost=click*cpc. The cpc model may not have a censorship problem. It may be assumed to be a linear function without intercept: cpc=β*bid. In such an example, the only coefficient in the model is the slope parameter β. A least squares model, or other model, may be used to fit the cpc model. The click model, on the other hand, includes a dependent variable (e.g., the number of clicks that can be right censored) that may be censored. The MLE technique described herein may be used to estimate the click model. To address the nonlinear relationship between bid and click, a sigmoid transformation may be applied to the dependent variable:

$${click}^{′} = log ( \frac{click}{upperbound ( click ) - click} )$$

where upperbound(click) denotes the upper bound of the number of clicks. Empirically, it can be calculated by multiplying the maximum number of clicks observed with a constant: upperbound(click)=a*max(clicks in the data). In this example, a is set to 1.3. After the sigmoid transformation, a linear function may be assumed as:

click′=β₀+β₁*bid.

Because the observation of dependent variable click′ can be censored, the MLE approach, as described herein, may be used. The covariate in this linear model is bid. Eventually, the number of clicks may be estimated by:

$$click = upperbound * \frac{exp ( {click}^{′} )}{1 + exp ( {click}^{′} )} .$$

Although the above example used a linear regression, similar concepts may apply to other types of regressions and data models. Accordingly, other types of regressions and data models may be used in some embodiments.

The predictive model may be used for a variety of purposes. For example, as shown at block 250 of FIG. 2, the model may be used to predict results (e.g., number of predicted responses) for a new campaign. Or, in some embodiments, the model may be used to adjust or create a new campaign by setting campaign parameters (e.g., bid amount) that optimize the predicted results. For instance, a different cost per response may be negotiated based on increased expectation of responses, a different budget constraint may be imposed, and/or a shorter duration advertising campaign with a similar budget constraint may be run.

FIG. 3 illustrates a chart of example predictive models that are generated according to various techniques based on four observations (three fully observed and one censored). The three darkened squares on the plot represent observations for fully observed responses for an online advertising campaign. For example, observation 304 may represent a bid value of 2 for an advertising campaign with a response value being 8. As it is a fully observed response, the budget constraint for fully observed response 304 (and the two other fully observed responses in the graph) has not been met in this example. For observation 302, represented by the darkened triangle, the budget constraint has been met such that the online advertising campaign was interrupted during the time period of the advertising campaign. Accordingly, the response value is censored.

The three lines represent three different predictive models. Line 306 represents a model that excludes any censored observation data points. Therefore, the model represented by line 306 only takes into account the fully observed observations (three darkened square observations) and does not consider censored observation 302. Line 308 represents a model that treats censored observation 302 as a fully observed response. Therefore, the model represented by line 308 takes into account the fully observed and censored observations and ignores the possibility that other responses and/or a larger response value could have been received had the budget not been met and the advertising campaign not been interrupted. Line 310 represents a model according to the disclosed techniques. According to the disclosed techniques, the actual response value may be larger than the censored/partially observed response value according to the censored observation. The model according to the disclosed techniques results in less bias and greater accuracy in prediction.

### Exemplary Computer System

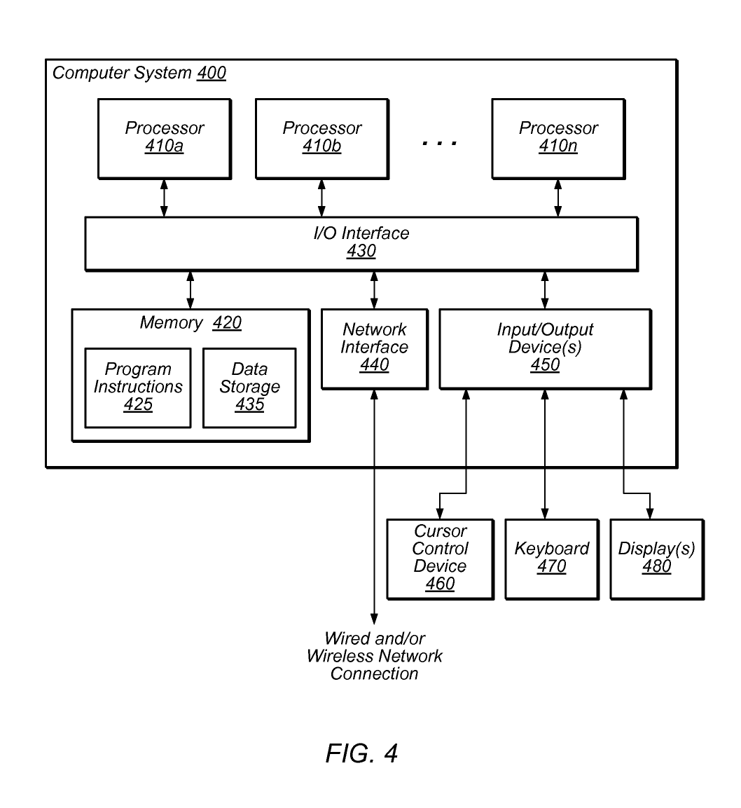

Various portions of a response prediction module may be executed on one or more computer systems, which may interact with various other devices. One such computer system is illustrated by FIG. 4. For example, publisher 130, advertiser 140, analytics provider 150, browser application 112, prediction module 160, receiving component 162, censored data detector 164, and prediction module generator 164 may each include, employ or be executed on one or more computer systems.

In the illustrated embodiment, computer system 400 includes one or more processors 410 coupled to a system memory 420 via an input/output (I/O) interface 430. Computer system 400 further includes a network interface 440 coupled to I/O interface 430, and one or more input/output devices 450, such as cursor control device 460, keyboard 470, audio device 490, and display(s) 480. In some embodiments, it is contemplated that embodiments may be implemented using a single instance of computer system 400, while in other embodiments multiple such systems, or multiple nodes making up computer system 400, may be configured to host different portions or instances of embodiments. For example, in one embodiment some elements may be implemented via one or more nodes of computer system 400 that are distinct from those nodes implementing other elements.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments, processors 410 may be general-purpose or embedded processors implementing any of a variety of instruction set architectures (ISAs), such as the x86, PowerPC, SPARC, or MIPS ISAs, or any other suitable ISA. In multiprocessor systems, each of processors 410 may commonly, but not necessarily, implement the same ISA.

In some embodiments, at least one processor 410 may be a graphics processing unit. A graphics processing unit (GPU) may be considered a dedicated graphics-rendering device for a personal computer, workstation, game console or other computer system. GPUs may be very efficient at manipulating and displaying computer graphics and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods disclosed herein for customizable sequence of content delivery may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 420 may be configured to store program instructions and/or data accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for an online advertising prediction method, are shown stored within system memory 420 as program instructions 425 and data storage 435, respectively. In other embodiments, program instructions and/or data may be received, sent or stored upon different types of computer-accessible media or on similar media separate from system memory 420 or computer system 400. Generally speaking, a computer-accessible medium may include storage media or memory media such as magnetic or optical media, e.g., disk or CD/DVD-ROM coupled to computer system 400 via I/O interface 430. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 440.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components. In addition, in some embodiments some or all of the functionality of I/O interface 430, such as an interface to system memory 420, may be incorporated directly into processor 410.

Network interface 440 may be configured to allow data to be exchanged between computer system 400 and other devices attached to a network, such as other computer systems, or between nodes of computer system 400. In various embodiments, network interface 440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or retrieving data by one or more computer system 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

Memory 420 may include program instructions 425, configured to implement embodiments of a prediction module as described herein, and data storage 435, comprising various data accessible by program instructions 425. In one embodiment, program instructions 425 may include software elements of an online advertising prediction method illustrated in the above Figures. Data storage 435 may include data that may be used in embodiments. In other embodiments, other or different software elements and/or data may be included.

Those skilled in the art will appreciate that computer system 400 is merely illustrative and is not intended to limit the scope of online advertising prediction as described herein. In particular, the computer system and devices may include any combination of hardware or software that can perform the indicated functions, including computers, network devices, internet appliances, PDAs, wireless phones, pagers, etc. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the disclosed embodiments may be practiced with other computer system configurations. In some embodiments, portions of the techniques described herein may be hosted in a cloud computing infrastructure.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the embodiments embrace all such modifications and changes and, accordingly, the above description to be regarded in an illustrative rather than a restrictive sense.

What is claimed is:

1. A method, comprising:
performing, by one or more computing devices:
receiving a censored observation for an online advertising campaign for a first given time period, wherein the censored observation corresponds to a first response value, wherein one or more campaign parameters are defined for the first given time period;
determining that an amount spent on the online advertising campaign met a first budget constraint such that the online advertising campaign was interrupted during the first given time period; and
based on the received observation and the one or more campaign parameters for the first given time period, generating a predictive model for predicting a result of a new online advertising campaign, wherein said generating includes determining a likelihood that a larger response value than the first response value would have occurred for the online advertising campaign absent the first budget constraint.

2. The method of claim 1, further comprising:
receiving a fully observed observation for the online advertising campaign for a second given time period, wherein the fully observed observation corresponds to a second response value, wherein another one or more campaign parameters are defined for the second given time period, and
wherein said generating the predictive model is further based on the one or more campaign parameters for the second given time period and on the received fully observed observation, wherein the second response value is used as an actual response value for the fully observed observation regardless of a second budget constraint.

3. The method of claim 2, wherein said determining a likelihood includes applying a maximum likelihood estimation technique to the censored observation to maximize a likelihood of both the first and second response values.

4. The method of claim 1, wherein said determining a likelihood includes applying a regression technique to the censored observation.

5. The method of claim 1, further comprising:
receiving an indication of the amount spent on the online advertising campaign, wherein said determining that the amount spent on the online advertising campaign met the first budget constraint is based on the received indication of the amount spent and the first budget constraint.

6. The method of claim 5, wherein the indication of the amount spent is received from a publisher of an online advertisement of the advertising campaign.

7. The method of claim 1, further comprising:
using the predictive model to predict a result of the new online advertising campaign.

8. A non-transitory computer-readable storage medium storing program instructions, wherein the program instructions are computer-executable to implement:
receiving a censored observation for an online advertising campaign for a first given time period, wherein the censored observation corresponds to a first response value, wherein one or more campaign parameters are defined for the first given time period;
determining that an amount spent on the online advertising campaign met a first budget constraint such that the online advertising campaign was interrupted during the first given time period; and
based on the received censored observation and the one or more campaign parameters for the first given time period, generating a predictive model for predicting a result of a new online advertising campaign, wherein said generating includes determining a likelihood that a larger response value than the first response value would have occurred for the online advertising campaign absent the first budget constraint.

9. The non-transitory computer-readable storage medium of claim 8, wherein the program instructions are further computer-executable to implement:
receiving a fully observed observation for the online advertising campaign for a second given time period, wherein the fully observed observation corresponds to a second response value, wherein another one or more campaign parameters are defined for the second given time period, and
wherein said generating the predictive model is further based on the one or more campaign parameters for the second given time period and on the received fully observed observation, wherein the second response value is used as an actual response value for the fully observed observation regardless of a second budget constraint.

10. The non-transitory computer-readable storage medium of claim 9, wherein said determining a likelihood includes applying a maximum likelihood estimation technique to the censored observation to maximize a likelihood of both the first and second response values.

11. The non-transitory computer-readable storage medium of claim 8, wherein said determining a likelihood includes applying a regression technique to the censored observation.

12. The non-transitory computer-readable storage medium of claim 8, wherein the program instructions are further computer-executable to implement:
receiving an indication of the amount spent on the online advertising campaign, wherein said determining that the amount spent on the online advertising campaign met the first budget constraint is based on the received indication of the amount spent and the first budget constraint.

13. The non-transitory computer-readable storage medium of claim 12, wherein the indication of the amount spent is received from a publisher of an online advertisement of the advertising campaign.

14. The non-transitory computer-readable storage medium of claim 8, wherein the program instructions are further computer-executable to implement:
using the predictive model to predict a result of the new online advertising campaign.

15. A system, comprising:
a receiving component configured to receive a censored observation for an online advertising campaign for a first given time period, wherein the censored observation corresponds to a first response value, wherein one or more campaign parameters are defined for the first given time period;
a censored data detector coupled to the receiving component to determine that an amount spent on the online advertising campaign met a first budget constraint such that the online advertising campaign was interrupted during the first given time period; and
a prediction module generator coupled to the censored data detector to, based on the received censored observation and the one or more campaign parameters for the first given time period, generate a predictive model for predicting a result of a new online advertising campaign, wherein said generating includes determining a likelihood that a larger response value than the first response value would have occurred for the online advertising campaign absent the first budget constraint.

16. The system of claim 15, wherein the receiving component is further configured to:
receive, from the analytics provider, a fully observed observation for the online advertising campaign for a second given time period, wherein the fully observed observation corresponds to a second response value, wherein another one or more campaign parameters are defined for the second given time period, and
wherein said generating the predictive model, by the prediction model generator, is further based on the one or more campaign parameters for the second given time period and on the received fully observed observation, wherein the second response value is used as an actual response value for the fully observed observation regardless of a second budget constraint.

17. The system of claim 16, wherein said determining a likelihood includes applying a maximum likelihood estimation technique to the censored observation to maximize a likelihood of both the first and second response values.

18. The system of claim 15, wherein said determining a likelihood includes applying a regression technique to the censored observation.

19. The system of claim 15, wherein said determining that the amount spent on the online advertising campaign met the first budget constraint is based on a received indication of the amount spent on the online advertising campaign and the budget constraint.

20. The system of claim 19, wherein the indication of the amount spent is received from a publisher of an online advertisement of the advertising campaign.
